(19) United States
(12) Patent Application Publication
(10) Pub. No.: US 2021/0398229 A1
(43) Pub. Date: Dec. 23, 2021

(54) SYSTEM AND METHOD FOR SCHEDULING AND MANAGING PROPERTY SHOWINGS

(71) Applicant: Showingly Inc., Denver, CO (US)

(72) Inventors: Andrew Coca, Thornton, CO (US); Jonathan Martinez, Brighton, CO (US)

(73) Assignee: Showingly Inc.

(21) Appl. No.: 17/322,331

(22) Filed: May 17, 2021

Related U.S. Application Data
(60) Provisional application No. 63/042,267, filed on Jun. 22, 2020.

(51) Int. Cl. G06Q 50/16; G06Q 10/06; G07C 9/00

(52) U.S. Cl. CPC G06Q 50/16; G07C 2009/00825; G07C 9/00817; G06Q 10/063116

(57) ABSTRACT

A property showing management system for managing showings of a listed property. The property showing management system including a consumer device associated with a prospective buyer who requests a showing of a listed property at a specific date and time. The property showing management system having an agent device associated with a real estate agent who can conduct showings of listed properties. The property showing management system further includes a showing control system for performing the operations of the property showing management system, the showing control system receives a showing request from the prospective buyer via the consumer device, determines a showing agent to conduct the showing of the listed property, and notifies the showing agent of the showing date and time via the agent device. A method of managing showings of listed properties. The method includes a showing request of a listed property received from a prospective buyer for a specific date and time. A showing agent can be determined to conduct a showing of the listed property with the prospective buyer at the specific date and time requested by the prospective buyer. The showing agent is then notified of the showing date and time.

### STATEMENT REGARDING FEDERALLY SPONSORED RESEARCH OR DEVELOPMENT

Not applicable.

### CROSS-REFERENCE TO RELATED APPLICATIONS

The present application is a conversion of U.S. Provisional Application having U.S. Ser. No. 63/042,267, filed Jun. 22, 2020, which claims the benefit under 35 U.S.C. 119(e). The disclosure of which is hereby expressly incorporated herein by reference.

### BACKGROUND OF THE DISCLOSURE

### 1. Field of the Invention

The disclosure relates to a property showing management system and method for scheduling and managing property showings for consumers and real estate agents and managing access to the property for real estate agents.

### 2. Brief Description of Related Art

Typically, when a prospective property buyer wants to schedule a showing to see a property (e.g., a house) that is listed for sale, the prospective buyer must contact the buyer's agent, the buyer's agent has to reach out to the seller's agent, who then reaches out to the seller, and a showing time is agreed upon after multiple rounds of communication. Scheduling property showings this way is cumbersome and inefficient for all parties.

Accordingly, there is a need for a technology based solution that allows the homebuyers, sellers, and real estate professionals to more easily set up and manage showings to view properties that are for sale.

### SUMMARY OF THE DISCLOSURE

The present disclosure is directed towards a property showing management system for managing showings of a listed property. The property showing management system including a consumer device associated with a prospective buyer who requests a showing of a listed property at a specific date and time. The property showing management system having an agent device associated with a real estate agent who can conduct showings of listed properties. The property showing management system further includes a showing control system for performing the operations of the property showing management system, the showing control system receives a showing request from the prospective buyer via the consumer device, determines a showing agent to conduct the showing of the listed property, and notifies the showing agent of the showing date and time via the agent device.

The present disclosure is also directed toward a method of managing showings of listed properties. The method includes a showing request of a listed property received from a prospective buyer for a specific date and time. A showing agent can be determined to conduct a showing of the listed property with the prospective buyer at the specific date and time requested by the prospective buyer. The showing agent is then notified of the showing date and time.

### BRIEF DESCRIPTION OF THE DRAWINGS

FIG. 1 is a diagram showing a property showing management system constructed in accordance with the disclosure.

FIG. 2 is a flow chart showing a general process of the property showing management system constructed in accordance with the disclosure.

FIG. 3 is a diagram showing a showing control system incorporated by the property showing management system in accordance with the disclosure.

FIG. 4 is a flow chart showing a detailed portion of the general process of the property showing management system constructed in accordance with the disclosure.

FIG. 5 is a flow chart showing a detailed portion of the general process of the property showing management system constructed in accordance with the disclosure.

FIG. 6 is a flow chart showing a detailed portion of the general process of the property showing management system constructed in accordance with the disclosure.

FIG. 7 is a flow chart showing a detailed portion of the general process of the property showing management system constructed in accordance with the disclosure.

FIG. 8 is a diagram of an exemplary smart lock that can be used with the property showing management system constructed in accordance with the disclosure.

FIGS. 9A-9F are a series of screenshots from a device used with the property showing management system constructed in accordance with the disclosure.

FIGS. 10A-10E is a series of screenshots from a device used with the property showing management system constructed in accordance with the disclosure.

FIG. 11A-11E is are a series of screenshots from a device used with the property showing management system constructed in accordance with the disclosure.

FIG. 12 is a screenshot from a device used with the property showing management system constructed in accordance with the disclosure.

### DETAILED DESCRIPTION OF THE DISCLOSURE

The present disclosure relates to a property showing management system (PSMS) 10 for managing and scheduling property showings. Typically, when a property owner wants to sell their property, they will engage a real estate agent to list the property with a property listing service, such as Multiple Listing Services (MLS). The real estate agent used by the property owner to sell the property is generally called a listing agent. The listing agent provides pertinent information about the property to be sold and the property is then listed with the property listing service for prospective buyers to view. If a potential buyer is interested in a listed property, the buyer can schedule a showing via a real estate agent associated with the buyer, typically known as a buying agent. Once a scheduled showing time is set, which is heavily dictated by the listing agent's and the buying agent's availability, the buyer's agent and the prospective buyer go to the listed property. A key to the property is typically secured in a lockbox placed on a door of the listed property. The agent conducting the showing will have a code that will allow them to access the key in the lockbox and provide the agent and the prospective buyer access to the property. As used herein, property can mean any real property capable of being sold. Examples of real property include, but are not limited to, buildings, such as homes, and land.

The PSMS 10 described herein can be used by consumers, such as property buyers and property sellers, and by real estate agents, such as property buyer's agents and property seller's agents (or listing agents) to manage the process of setting up a showing of a property. In other embodiments, the PSMS 10 can be used by real estate brokerages and other professional service providers associated with property purchases, such as money lenders (or banks), property appraisal services, title companies, property insurance providers, and property inspection services.

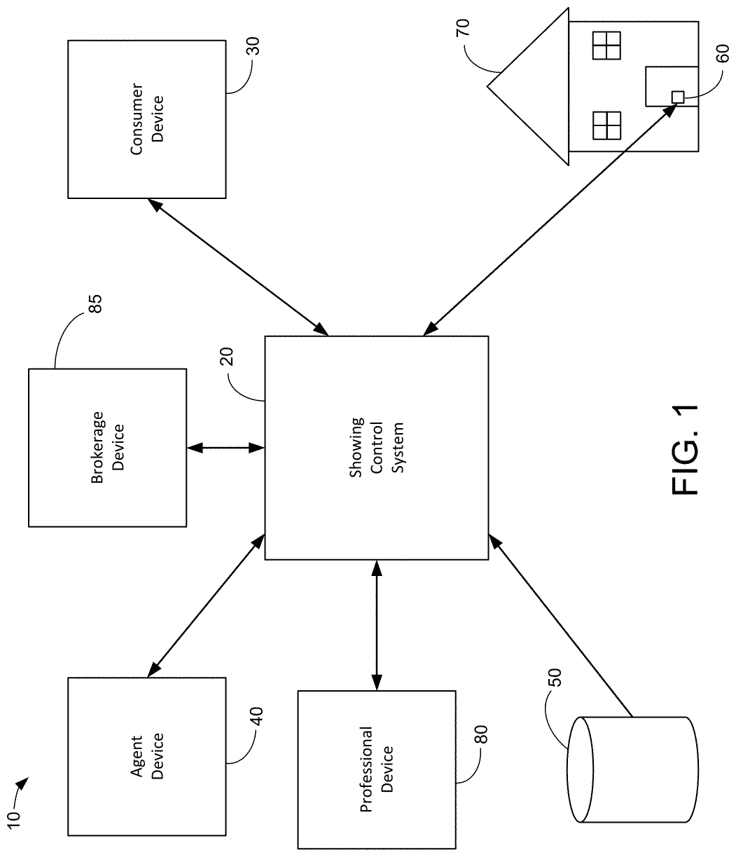

Referring now to the drawings, and more particularly, FIG. 1 shown therein is the PSMS 10. The PSMS 10 includes a showing control system 20 for facilitating the operations of the PSMS 10. The showing control system 20 is configured to send and receive data to and from a consumer device 30 and an agent device 40. The showing control system is also configured to carry out all operations of the PSMS 10 described herein. The consumer device 30 can be a tablet, smart phone or computer used by a consumer (buyer or seller) that is running an application (app) or accessing a webpage associated with the PSMS 10. Similarly, the agent device 40 can be tablet, smart phone or computer used by a real estate agent that is running an application (app) or accessing a webpage associated with the PSMS 10. It should be understood and appreciated that while only one consumer device 30 and one agent device 40 is shown in FIG. 1, the showing control system 20 of the PSMS 10 is capable of receiving and sending data to numerous consumer devices 30 and numerous agent devices 40. The showing control system 20 can be configured to receive data from a property listing database 50, such as MLS described herein. The PSMS 10 can also include a smart lockbox 60 coupled to a property 70 listed in the property listing database 50. The lockbox can be configured to send and receive information to and from the showing control system 20.

In another embodiment of the present disclosure, the PSMS 10 can include a professional device 80 that can send and receive information to and from the showing control system 20 and a brokerage device 85 that can send and receive information to and from the showing control system 20. The professional device 80 and the brokerage device 85 can be a tablet, smart phone or computer used by a professional service provider or a broker that is running an application (app) or accessing a webpage associated with the PSMS 10. The professional service provider can be any service related to the real estate purchase industry. Examples of professional service providers include, but is not limited to, title companies, lending institutions (i.e., banks, credit unions, etc.), property inspection services and insurance providers. It should be understood and appreciated that while only one professional device 80 is shown in FIG. 1, the showing control system 20 of the PSMS 10 is capable of sending and receiving data to and from numerous professional devices 80.

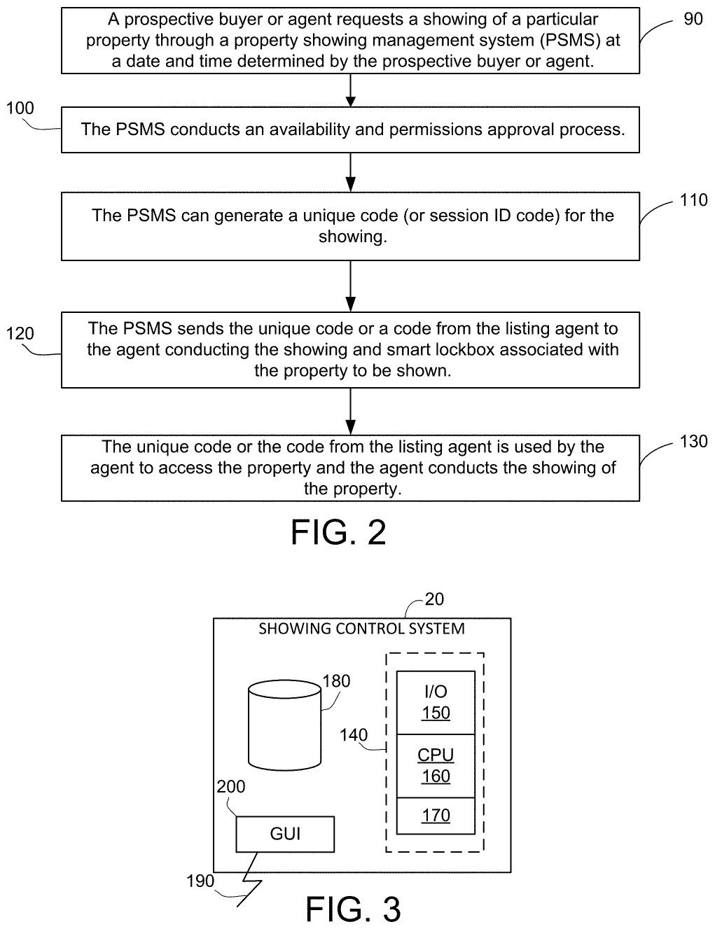

Referring now to FIG. 2, shown therein is a flow chart showing a general process the PSMS 10 manages. At step 90, a prospective buyer or agent requests a showing of a property via the consumer device 30 or agent device 40 and sets a time and date desired for the showing. The showing control system 20 of the PSMS 10 conducts an availability and permissions approval process at step 100 to determine if the agent may show the property to the prospective buyer at the time and date requested by the prospective buyer. The showing control system 20 then conducts operation 110 and either generates a unique code for the lockbox 60 associated with the property 70 for the specific showing scheduled for the date and time set by the prospective buyer or uses a code generated by the listing agent. The code is then sent by the showing control system 20 to the agent showing the property 70 and/or to the smart lockbox 60 at operation 120. The showing agent can then perform step 130 and use the code to open the lockbox 60, obtain a key to the property 70 and conduct the showing. After the showing at step 130, the PSMS 10 can then be used to schedule additional showings of the property at different dates and times with new unique codes associated with each showing.

Referring now to FIG. 3 shown therein is a diagram of the showing control system 20. The showing control system 20 is capable of executing a computer program product embodied in a tangible processor-readable storage medium to execute a computer process. Data and program files may be input to the showing control system 20, which reads the files and executes the programs therein using one or more processors. Some of the elements of the showing control system 20 are shown in FIG. 3, wherein a processor 140 is shown having an input/output (I/O) section 150, a Central Processing Unit (CPU) 160, and a memory section 170. There may be one or more processors 140, such that the processor 140 of the showing control system 20 comprises a single central-processing unit 160, or a plurality of processing units. The processors may be single-core or multi-core processors. The showing control system 20 may be a conventional computer, a distributed computer, or any other type of computer. The described technology is optionally implemented in software loaded in memory 170, a disc storage unit 180, and/or communicated via a wired or wireless network link 190 on a carrier signal (e.g., Ethernet, 3G wireless, 1G wireless, LTE (Long Term Evolution), 5G) thereby transforming the showing control system 20 in FIG. 3 to a special purpose machine for implementing the described operations.

The I/O section 150 may be connected to one or more user-interface devices (e.g., a keyboard, a touch-screen display unit, etc.) or a disc storage unit 180. Computer program products containing mechanisms to effectuate the systems and methods in accordance with the described technology may reside in the memory section 170 or on the storage unit 180 of the showing control system 20.

The showing control system 20 can also include a communication interface 200 capable of connecting the showing control system 20 to an enterprise network via the network link 190, through which the showing control system 20 can receive instructions and data embodied in a carrier wave. When used in a local area networking (LAN) environment, the showing control system 20 is connected (by wired connection or wirelessly) to a local network through the communication interface 200, which is one type of communications device. When used in a wide-area-networking (WAN) environment, the showing control system 20 typically includes a modem, a network adapter, or any other type of communications device for establishing communications over the wide-area network. In a networked environment, program modules depicted relative to the showing control system 20 or portions thereof may be stored in a remote memory storage device. It is appreciated that the network connections shown are examples of communications devices for and other means of establishing a communications link between the computers may be used.

In an example implementation, a browser application, a compatibility engine applying one or more compatibility criteria, and other modules or programs may be embodied by instructions stored in memory 170 and/or the storage unit 180 and executed by the processor 140. Further, local computing systems, remote data sources and/or services, and other associated logic represent firmware, hardware, and/or software, which may be configured to assist in scheduling a home showing. The showing control system 20 of the PSMS 10 may be implemented using a general-purpose computer and specialized software (such as a server executing service software), a special purpose computing system and specialized software (such as a mobile device or network appliance executing service software), or other computing configurations. In addition, user requests, profiles and parameter data, agent profiles and parameter data, location data, parameter matching data, and other data may be stored in the memory 170 and/or the storage unit 180 and executed by the processor 140.

The embodiments of the invention described herein are implemented as logical steps in one or more computer systems. The logical operations of the present invention are implemented (1) as a sequence of processor-implemented steps executed in one or more computer systems and (2) as interconnected machine or circuit modules within one or more computer systems. The implementation is a matter of choice, dependent on the performance requirements of the computer system implementing the invention. Accordingly, the logical operations making up the implementations of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

Data storage and/or memory may be embodied by various types of storage, such as hard disk media, a storage array containing multiple storage devices, optical media, solid-state drive technology, ROM, RAM, and other technology. The operations may be implemented in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” (e.g., memory 170) means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” or “storage medium” expressly does not include a transitory medium, such as a carrier signal, but the computer instructions can be transferred to the memory wirelessly.

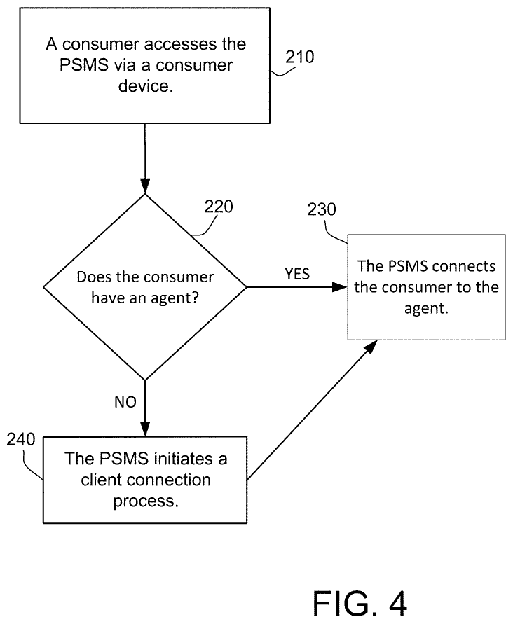

Referring now to FIG. 4, shown therein is a portion of the process contemplated by the PSMS 10. To start at step 210, a consumer, such as a prospective buyer or seller, can access the PSMS 10 on an application (app) downloaded to the consumer device 30 or through a website accessed via a browser on the consumer device 30. The consumer can view listings on the PSMS 10, register with the PSMS 10 and upload various information relative to the consumer to the PSMS 10. At step 220, the PSMS 10 can receive information regarding whether the consumer has an agent or does not have an agent. If the consumer does have an agent, the PSMS 10 can connect the consumer to their agent at step 230. In one embodiment, if the agent is not registered with the PSMS 10, the PSMS 10 permits the consumer to enter information about their agent (e.g., name, email, phone number, address, etc.) or the PSMS 10 permits the consumer to select their agent from a list of agents in the area that are not registered with the PSMS 10. The PSMS 10 can also be configured to send an invitation to the unregistered agent of the consumer to join and register with the PSMS 10. At step 240, if the consumer communicates to the PSMS 10 that the consumer does not have an agent, the PSMS 10 can initiate a client connection process to connect a consumer to an agent.

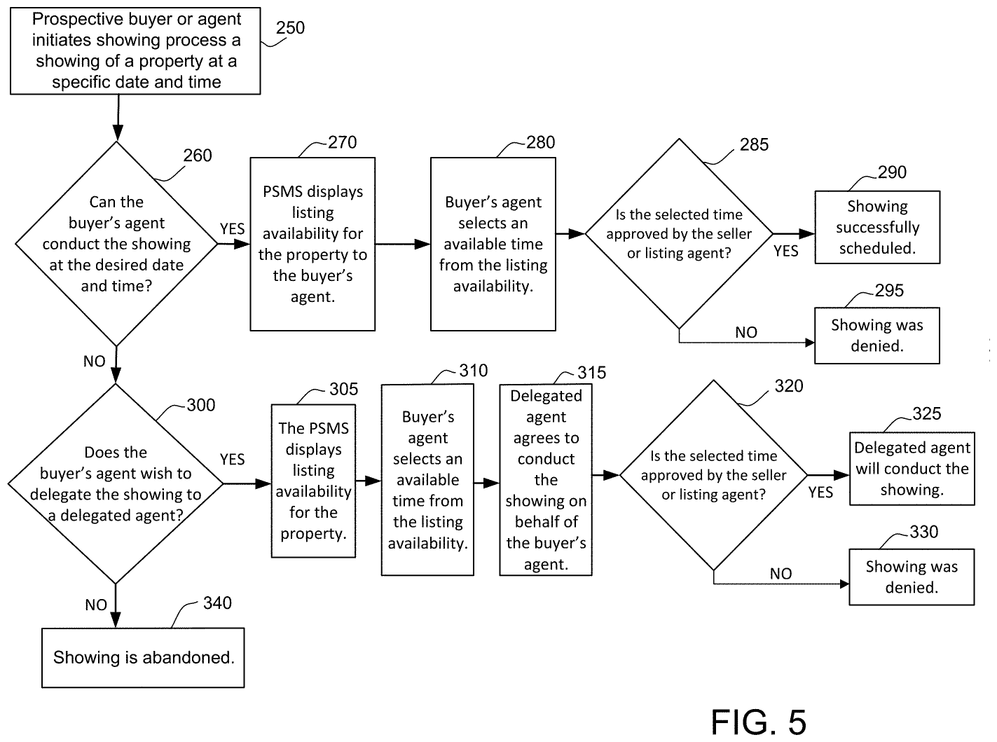

FIG. 5 provides a flow chart for when a prospective buyer, via a consumer device 30, or a buyer's agent, via an agent device 40, initiates a scheduling process for a particular property at a desired date and time via the PSMS 10. This is shown at step 250. If, at step 260, the PSMS 10 determines that the buyer's agent can conduct the showing at the requested time, the PSMS 10 displays a listing availability for the property on the buyer's agent's device 40 at step 270. The buyer's agent can then select an available time from the listing availability via the agent's device 40 at step 280. The PSMS 10 can notify the seller or listing agent, via the seller's consumer device 30 or the listing agent's device 40, that a request for a showing has been selected from the listing availability. At operation 285, the seller or listing agent can approve or decline the requested showing time. If the requested showing time is approved by the seller or the listing agent, the buyer's agent conducts a successful showing at step 290. If the seller or listing agent rejects the requested time of showing by the prospective buyer and/or the buyer's agent, the showing will be denied at step 295.

If the buyer's agent cannot conduct the showing at the desired date and time desired by the prospective buyer, the PSMS 10 can conduct operation 300 and send notification to agents registered with the PSMS 10 that the buyer's agent would like to delegate a showing to another agent. The agent, via the agent's device 40, who accepts the delegated showing is the delegated agent and may receive an incentive, such as money, from the buyer's agent (delegating agent), to conduct a delegated showing for the buyer's agent. This operation is called a delegation operation. The PSMS 10 is configured and designed to accept and transfer money associated with the delegated showing. At step 305, the PSMS 10 displays a listing availability for the property where the buyer's agent can select an available time from the listing availability at step 310. The delegated agent can then agree to conduct the showing on behalf of the buyer's agent at step 315. Similar to when the buyer's agent can do the showing and has requested a certain time from the availability listing displayed on the agent's device 40 by the PSMS 10, at step 320 the seller or listing agent can approve or disprove the showing request. If the seller or listing agent approves the requested showing time for the delegated agent, the delegated agent will conduct the showing at step 325. If the seller or listing agent deny the request to show the property at the requested time, the showing is denied at step 330.

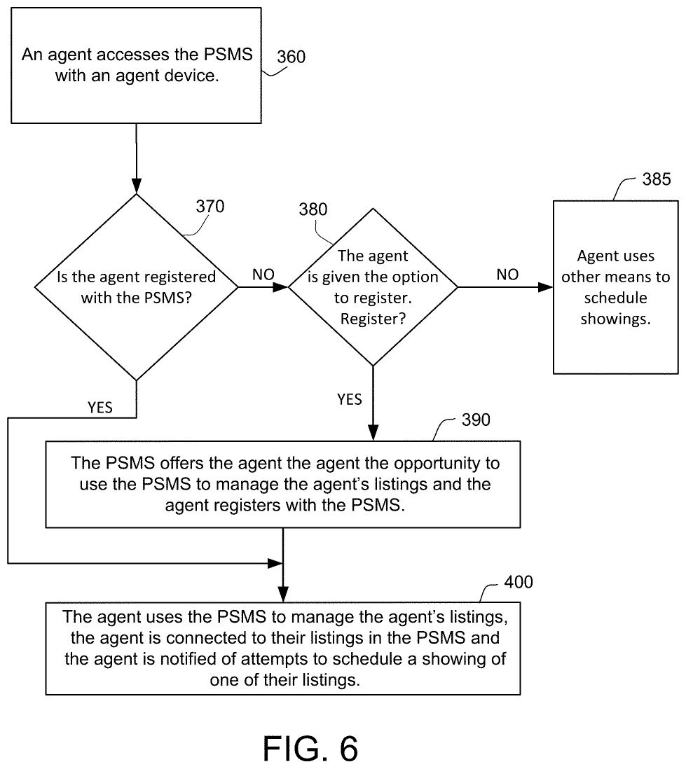

FIG. 6 depicts an exemplary process when an agent accesses the PSMS 10 via an agent device 40. At step 360 an agent accesses the PSMS 10 via the agent device 40. The agent can access the PSMS 10 for any number of reasons. After the agent accesses the PSMS 10, operation 370 will occur and the PSMS 10 will determine if the agent is registered on the PSMS 10, which can be done by the PSMS 10 requesting the information from the agent or by the agent logging into PSMS 10. If the PSMS 10 determines that the agent is not registered, the option of registering with the PSMS 10 is provided to the agent at step 380. If the agent declines to register with the PSMS 10 (doesn't intend to use the PSMS 10) then that agent will not be able to use the PSMS 10. If the PSMS 10 determines in operation 370 that the agent is registered with the PSMS 10 or the agent registers with the system at step 380, the PSMS 10 will perform operation 390 and offer the agent the opportunity to use the PSMS 10 to manage their listings. If the agent decides to use the PSMS 10 to manage their listings, that agent will be connected to their listings and will be notified and/or asked for permission when prospective buyers are trying to schedule a showing for a listing of the agent—step 400. If the agent does not use the PSMS 10 to manage their listings then any showing attempted by a prospective buyer through the PSMS 10 would potentially cause the prospective buyer and/or the buyer's agent to clear hurdles to get a showing scheduled.

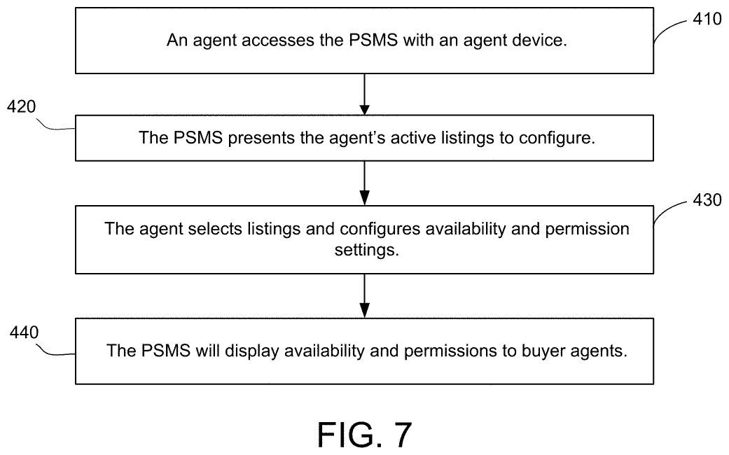

FIG. 7 depicts an exemplary process wherein a listing agent performs operation 410 and accesses the PSMS 10 with an agent device 40 to manage the listing agent's listings. After the listing agent has accessed the PSMS 10 with their agent device 40, the PSMS 10 presents the agent's active listings to configure at step 420. The listing agent can select their listings and configures availability and permission settings for each listing at step 430. The availability and permission settings set when a particular property can be shown and who can give permission to show the property. The listing agent can also upload to the PSMS 10 any other information about the property desired. The PSMS 10 can then conduct operation 440 and display the availability of showing times for the various listings to the buyer agents via their agent devices 40.

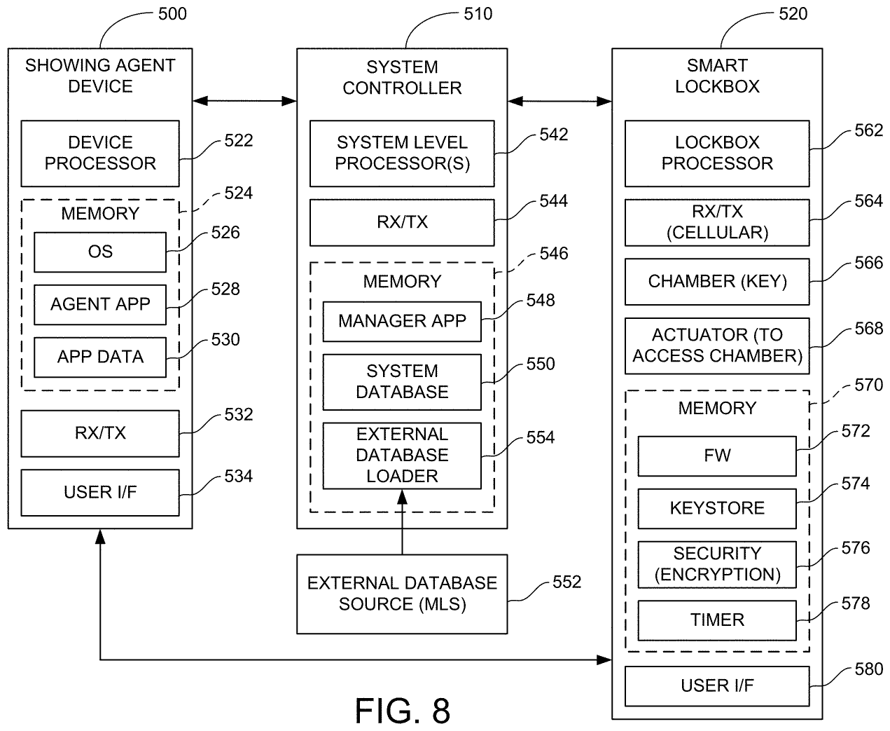

Once a showing has been scheduled by the PSMS 10, the PSMS 10 will generate a unique code for the smart lockbox 60 associated with the property to be shown. A unique code is generated for each separate showing of a property. The unique code can be sent to the smart lockbox 60 and the agent conducting the showing. FIG. 8 is a functional block representation of relevant aspects of the PSMS 10 in accordance with some embodiments. The various elements shown in FIG. 8 carry out various operations as described above in FIGS. 1-7 during a scheduled in-person showing of a property to a potential buyer. It will be appreciated that FIG. 8 is merely illustrative and is not limiting, as other configurations and combinations of devices can be used as desired.

The system includes a showing agent device 500, a system controller 510 and a smart lockbox 520. Each of these will be discussed in turn. The showing agent device 500 generally corresponds to the agent device 40 in FIG. 1 and may be a portable network accessible device such as a smart phone, tablet, computer, etc. carried and used by the agent during the in-person showing of the property to the buyer. As noted above, this agent may be the listing agent, the buyer's agent, the delegated agent, etc. While it is contemplated that the showing agent will utilize a portable device during the in-person showing, this is not necessarily required. In other embodiments, other access arrangements may be used so that the showing agent device 506 may take some other suitable form, including but not limited to a desktop computer, etc.

The system controller 510 generally corresponds to the showing control system 20 of FIG. 1, and may be in the form of a network computer, a remote server, a cloud service accessible over a network such as the Internet, etc. The showing agent device 500 may communicate with the system controller 510, and vice versa, prior to, during and after the in-person showing of the property. The smart lockbox 520 generally corresponds to the lockbox 60 in FIG. 1, and is positioned adjacent a door of the property to be shown (e.g., 70) to provide controlled access to the property. As before, communications may be carried out between the smart lockbox 520 and the respective showing agent device 500 and/or the system controller 510 before, during and after the in-person showing.

In the present example, it will be contemplated that the showing agent device 500 constitutes a smart cellular phone, although such is not limiting. As such, the device 500 includes various elements including a device processor 522 and associated memory 524. The processor 522 is contemplated as comprising one or more programmable processors which execute various program instructions stored in the memory 524, including those of an operating system (OS) 526 and an agent application (app) 528 of the PSMS 10. App data 530 are accumulated, stored and transmitted as required during execution of the agent app 528. Communications circuitry 532 has receiver and transmitter (RX/TX) capabilities to enable network communications with the other elements in the system. These communications are contemplated as including, but not necessarily limiting to, wireless (or wired) communications over substantially any available type and style of network and interface, including but not limited to cellular, 4G, 5G, Bluetooth, NFC, USB, etc. A user interface (I/F) 534 may include a touchscreen or other interface device(s) to enable user access to the functionality of the agent app 528.

The system controller 510 is contemplated in the present example as being realized in a public or private cloud environment and is accessible via associated distributed network communications (including cellular, TCP/IP, etc.). The system controller 510 includes one or more system level programmable processors 542. Communication (RX/TX) circuitry 544 enables network communications with the other elements in the system. A controller memory 546 stores various types of programming and data used by the processor(s) 542 including a manager app 548 and a system database 550. The manager app 548 enables the system controller 510 to manage the various operations of the system as described herein. The system database 550 is a data structure stored in the memory to track the status of the various showings and transactions taking place within the system. The database can be arranged in any number of suitable ways. In one embodiment, the database includes entries for each property, with each entry tracking the associated data such as general information (address, asking price, features, etc.), status, the various agents, sellers and potential buyers involved with the property, history data regarding the property (including number of showings, associated dates/times, etc.), and so on. Further details regarding the types of data managed by the system database will be provided below.

While not limiting, it is contemplated in at least some embodiments that the various properties accessed by the system will be uploaded from an external source. In this way, substantially all of the available properties in each geographic area that are currently for sale will be accessible and viewable by the system, independently of whether the sellers have opted to utilize the PSMS 10. To this end, an external database source 552, such as provided by MLS, can be accessed by an external database loader 554. Updates from the MLS (or other source of listings) are periodically imported into the system, enabling the system database 550 to be updated on a regular basis.

As noted previously, the smart lockbox 520 is configured to be placed in an appropriate location adjacent the property to be shown to provide secure and easy access to keys used to gain authorized entry into the property. Any number of configurations can be used; one illustrative configuration involves a “traditional” lockbox arrangement in which the box is affixed to a handle of the front door of the property for easy access, and access codes are handled separately by the seller as discussed above. However, the use of a smart lockbox such as 520 provides a number of advantages to the users of the system. To this end, the smart lockbox 520 includes a lockbox processor 562, which as before may be a programmable processor configured to execute program instructions in local processor memory during operation. The smart lockbox 520 further includes communication (RX/TX) circuitry 564. It is contemplated, albeit not necessarily required, that this circuitry 564 includes cellular capabilities, such as via a 5G cellular network with an associated SIMM card, etc. to enable fast, reliable and secure communications with the system controller 510. Other communication capabilities can be additionally or alternatively incorporated into the circuitry 564; for example, in cases where wireless communications with the showing agent device 500 are desired, near-field communication (NFC), Bluetooth, etc. interfaces and protocols can be utilized as well.

The lockbox 520 further includes an interior chamber 566 to accommodate the key for the front door or other access point of the property. The chamber 566 is normally closed and locked in a secure fashion using a suitable cover or other arrangement. An actuator 568 is activated, as explained below, to open the chamber 566 to facilitate access to the key. Any number of different types of actuators 568 can be utilized as desired, such as a motor, a solenoid, etc. While not expressly shown, additional components of the smart lockbox may be incorporated into the system to enable the various functions described herein such as a suitable power source, a locking attachment mechanism to secure the lockbox to the property, proximity sensors to sense the presence of personnel, and so on.

A memory 570 stores various forms of programming and data utilized by the lockbox processor 562, including program instructions (firmware, FW) 572, an internal keystore 574, a security module 576, and a timer circuit 578. In some cases, an integrated design may be used (e.g., system on chip, SOC) so that at least some or all of the memory 570 is embedded internally into one or more integrated circuits that also incorporate the processor 562. The FW 572 provides overall operation of the lockbox during execution by the processor 562. The keystore 574 may be an internal memory location not accessible via external pins but accessible to the processor to store security information, such as the aforementioned session ID code (value) and other information such as encryption keys, a list of approved devices, a list of times/dates for scheduled showings, etc. The security module 576 applies appropriate cryptographic functions, such as encryption, to at least certain data transfers with the lockbox 520. The timer 578 can be used to delineate various elapsed periods of time, including authorized intervals during which access may be made via an authorized party to the chamber 566. As desired, the smart lockbox 520 may further have a user I/F 580, such as a keypad, etc.

The showing agent device 500, system controller 510 and smart lockbox 520 of FIG. 8 operate as described above to facilitate an in-person showing of a selected property. Actions may include prior communications between the showing agent device 500 (or another agent device) and the system controller 510 to schedule a particular showing event at a selected time/date. A unique session ID value may be generated and assigned to this particular showing event by the system controller 510, which in turn communicates this information to the smart lockbox 520 for storage in the secure keystore 574. This information may also be communicated to the showing agent device 500 as well, although such is not necessarily required. The data may be encrypted by the system controller 510 prior to transmission to the lockbox 520 and device 500. If multiple showings have been scheduled for different combinations of dates, times, potential buyers, showing agents, etc., each of these sessions will be separately scheduled and assigned a different session ID value. The session ID values may be generated in any number of ways, including through the use of a random number generator (RNG). The session ID values and other associated information will be stored by the lockbox 520 in the keystore 574. The information can be transmitted to the lockbox as soon as the sessions have been scheduled, or the information can be transmitted on a just-in-time basis (e.g., some short period of time prior to the actual scheduled showing, etc.). In some cases, the information associated with a particular showing may include other information as well, such as personally identifying data (PID) associated with the showing agent or the showing agent's device, etc.

At the time of a scheduled showing, the showing agent and the potential buyer will arrive at the property, and the showing agent will interface with the smart lockbox 520. This can be carried out in a number of different ways, depending on the requirements of a given application. In one example, the showing agent is transmitted the unique session ID value, and this value is displayed on the user I/F 534 of the showing agent device 500. As desired, this session ID value may not become visible and available to the showing agent until shortly before the time of the scheduled appointment. The showing agent can access the user I/F 580 of the smart lockbox to enter the session ID value to gain access to the key within the chamber 566.

In another example, the showing agent device 500 is brought near to establish a connection with the smart lockbox 520 (such as via Bluetooth, NFC, etc). In this case, an automated authentication exchange is carried out between the showing agent device 500 and the smart lockbox 520 to authenticate the device 500 to the lockbox 520. In some cases, the system controller 510 can be involved in this authentication process. Any number of authentication sequences can be employed including certificates, public/private encryption, challenge values, HMAC values, etc. to authenticate and authorize access. Additional security levels and actions can be implemented as desired to authenticate the showing agent in addition to the showing agent device, such as entry of the PID, etc. Regardless, the authentication processing will serve to authenticate, to the smart lockbox 520, that a valid session is being initiated, and this authentication processing will include confirmation that the correct session ID value has been presented for this particular showing, since each session ID value is only valid for an associated time period associated with the showing (e.g., during the entirety of the showing period, during the first 15 minutes of the showing period, for some interval of time just before and just after the scheduled time for the showing, etc.). These and other features may be user selectable.

The smart lockbox 520 will be configured to carry out a number of different internal operations in response to a request to grant access. These operations may include encryption/decryption of various values, including values presented to the lockbox by the showing agent, the showing agent device and/or the system controller; comparison operations; other authentication operations; upon successful authentication, activation of the actuator to grant access to the chamber; sensing of the removal and subsequent replacement of the key; various timing functions using the timer 578 to ensure that the correct session ID value has been presented during the date/time window during which the session ID value is valid, the recording of the length of the session, and so on; and transfer of history data to the system controller 510 or other elements in the system at the conclusion of each valid session. In this way, it can be seen that the PSMS 10 provides the capability to change and track the session ID values as often as required in an automatic and seamless fashion. Each individual session will have its own unique session ID value assigned by the system controller. This session ID value will only work for that showing, after which the session ID value will be disabled by the lockbox. The session ID values stored by the lockbox can be stored in encrypted form in the keystore, and only transmitted between the various deices in encrypted form. Moreover, the system maintains as part of the system database all accesses to each property, including the personnel involved, dates/times employed, etc.

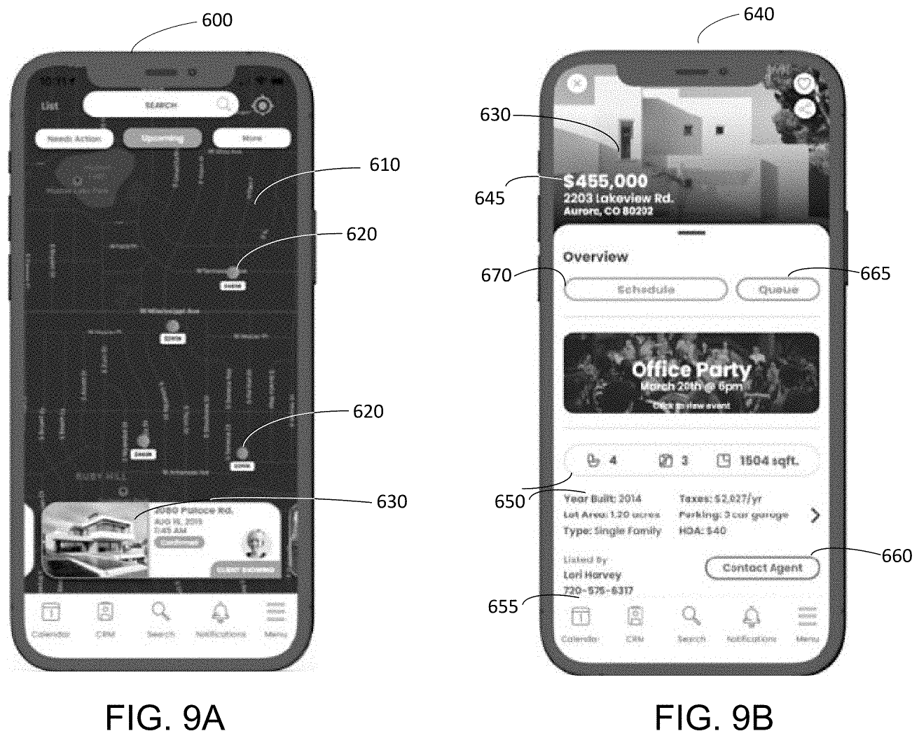

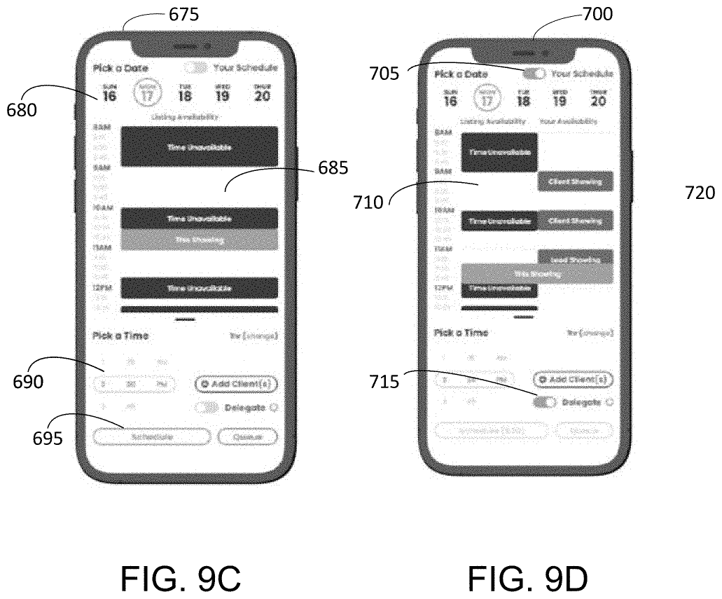

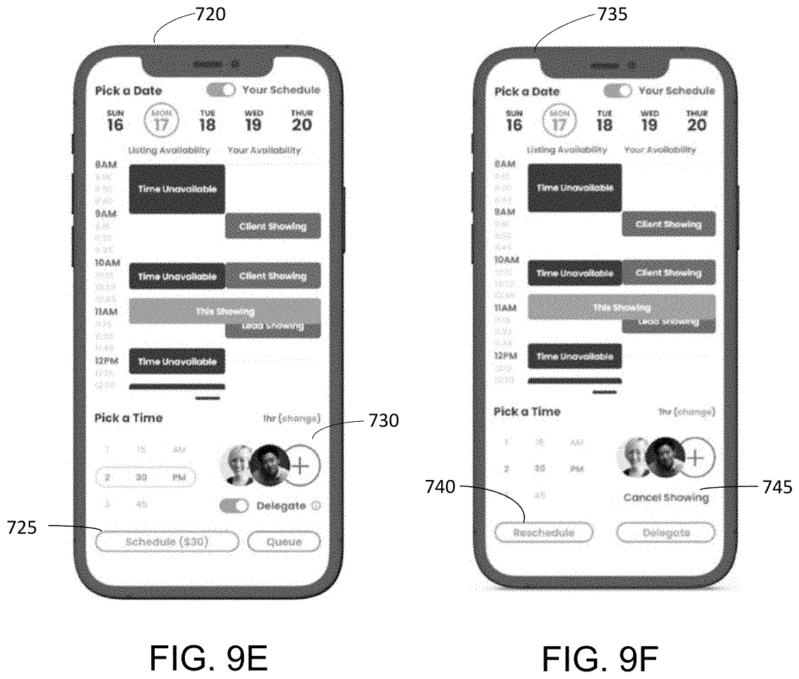

Referring now to FIGS. 9A and 9B, shown therein are screens shots taken from a consumer device 30 or an agent device 40 that has an application associated with the PSMS 10. FIG. 9A is a screenshot 600 showing a map 610 of a particular geographic area with listed properties 620 stored on the memory 170 or the disc storage unit 180 of the showing control system 20. The screenshot 600 can also show a property picture 630 associated with whichever listed property 620 is selected on the map 610 by the prospective buyer. The listed properties 620 can only be the listed properties associated with a particular real estate agent, so a listing agent can view all of their listed properties that agent has listed. Once a particular listed property is selected, another screenshot 640 can be displayed on the consumer device 30 or the agent device 40 as shown in FIG. 9B. A consumer or agent could also access the screenshot 40 by following a link from a real estate website, such as a MLS website. The screenshot 640 can show the property picture 630 and other information about the property. A first property information section 645 can be displayed in the screenshot 640. The first property information section can include the address of the property, the asking price for the property, how many bedrooms and bathrooms the property has, how much square footage the listed property includes, etc, or any combination thereof. The screenshot 640 can also include a second property information section 650 that can provide additional details about the listed property. Examples of additional details that can be included in the second property information section 650 include, but are not limited to, number of bedrooms, number of bathrooms, the year built, garage size, lot size, estimated taxes per year, number of stories, home owners association (HOA) dues, etc.

The screenshot 640 shown in FIG. 9B also includes a listing agent section 655 where the name of the listing agent and contact information for the listing agent can be provided. The screenshot 640 can also have a contact button 660 that the buying agent or the consumer can engage to contact the listing agent directly. The screenshot 640 can provide a queue button 665 for providing the buyer's agent or consumer a link to a page where all the listings they are interested in can be saved in one location and a schedule button 670 for providing the buyer's agent or the consumer a link to a scheduling screenshot 675 that provides a listing availability for the desired listed property.

An exemplary example of the scheduling screenshot 675 is shown in FIG. 9C. The scheduling screenshot 675 can include a date section 680 for allowing the prospective buyer, solely or via the buyer's agent, to choose a date they would like to schedule a showing of the listed property. For each date selected by the prospective buyer or buyer's agent, a preferred showing time can be selected from a listing availability section 685, which shows available showing times, via the operational features of the consumer device 30 or the agent device 40, such as via a touchscreen. If no available showing time is available for the desired date and time, the prospective buyer or the buyer's agent can select a preferred time for a specific date from a time section 690 shown in the scheduling screenshot 675. The preferred date and time request will be sent to the listing agent's device 40 and the sellers consumer device 30 for approval of the requested date and time. The listing agent or the seller approves the requested showing time or a requested showing time is available from the listing availability section 685, then the showing will be shown in the agent's scheduled showings portion of the agent device 40. Once the preferred date and time is set, the prospective buyer or buyer's agent can initiate the scheduling confirmation process by executing a schedule showing button 695 displayed on the screenshot 675. Once the scheduling process is initiated by the prospective buyer or the buyer's agent, the PSMS 10 executes the operations described herein to determine which agent will conduct the showing. FIG. 9D shows a screenshot 700 of an agent's device 40 where a full schedule button 705 has been activated that displays the agent's schedule overlapping the listing availability to generate a full schedule section 710. The full schedule section 710 can be used to determine if the buyer's agent has any conflict with the desired showing time.

If there is a scheduling conflict, the buyer's agent has the option to initiate a showing delegation operation via a delegate button 715 on the screenshot 700. The PSMS 10 performs the showing delegation operations where one agent can delegate a showing to another agent (or showing assistant) wherein the delegating agent offers an incentive (e.g., money or some other thing of value) to the delegated agent (or showing assistant) to conduct the showing. Referring now to FIGS. 9E and 9F, shown therein is a series of screenshots from an agent device 40 showing various operational aspects of the PSMS 10 when a buyer's agent initiates a delegation operation. FIG. 9E shows a delegation screenshot 720 on an agent's device 40 after a buyer's agent decides to delegate a showing that the buyer's agent cannot conduct. The delegation screenshot 720 includes a reward tab 725 that shows the incentive (e.g., the amount of money) the delegating agent will send the showing assistant that agrees to conduct the scheduled showing for the delegating agent. The agent device 40 can also include a client section 730 on a number of the screenshots that permit the agent to incorporate information for their clients from a customer relation management (CRM) system of the PSMS 10. FIG. 9F shows a showing option screenshot 735 that provides an agent with options about how to proceed with a scheduled showing that may have scheduling issues. The showing option screenshot 735 includes a reschedule button 740 that would permit the buyer's agent to attempt to find a new time for to try and conduct the showing that works for everyone required to have a successful showing. The showing option screenshot 735 can also include a cancel showing section 745 that permits the agent to cancel the showing.

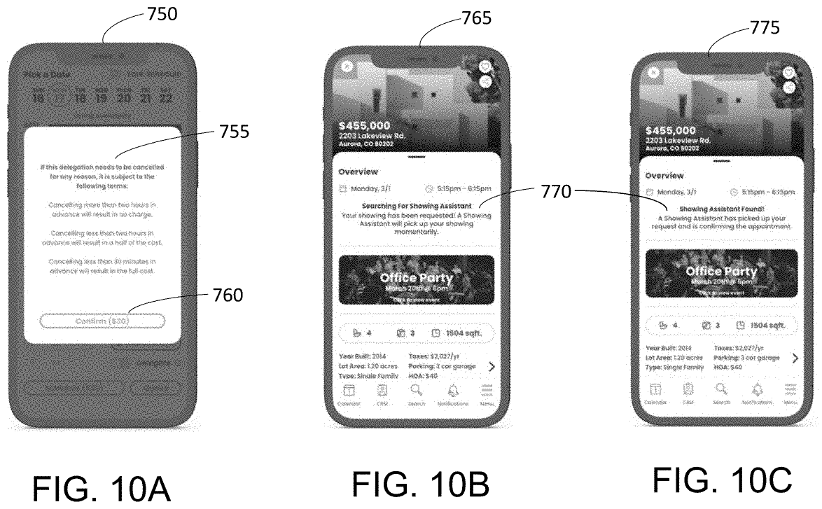

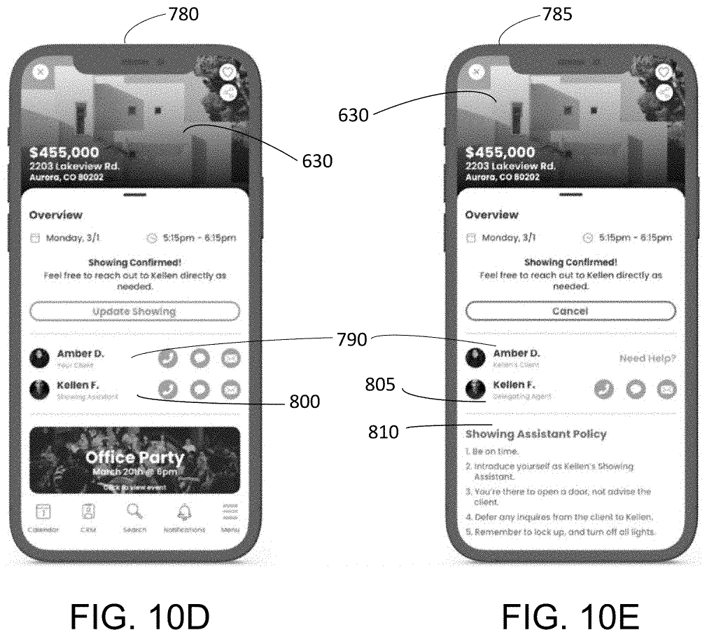

The PSMS 10 manages the showing delegation operation via the agent devices 40. FIGS. 10A-10D show various screenshots from the agent devices 40 when a showing delegation operation has been initiated. FIG. 10A shows a delegation confirmation screenshot 750 that includes a confirmation information section 755 that can provide various information about confirming the delegation of the showing and any potential other information desirable. For example, the confirmation information section 755 could include information regarding potential outcomes if the delegated showing is cancelled by the delegating agent after being confirmed. The delegation confirmation screenshot 750 can also include a confirmation button 760 that the delegating agent can activate when the delegating agent wants to delegate the showing to a showing assistant. After a delegating agent confirms that he or she wants to delegate a scheduled showing, the PSMS 10 can send out a notification to agents associated with the PSMS 10 that a potential delegation is available. If an agent is interested in the potential delegation, the agent can notify the PSMS 10 that the agent is interested in being the showing assistant for the delegated showing. The delegating agent can see a pending screenshot 765 on the agent device 40 while the PSMS 10 communicates with various agents to find a showing assistant. The pending screenshot 765 can include a photo of the property at issue, the date and time of the showing being delegated, and any information about the property desired. The pending screenshot 765 can also include a status section 770 to provide the delegating agent with information regarding the progress of finding a showing assistant. FIG. 10C shows a confirmation screenshot 775, which can show all the same information as that shown in the pending screenshot 765 with the exception of the information contained in the status section 770.

FIGS. 10D and 10E show a delegating agent overview screenshot 780 and a showing assistant overview screenshot 785, respectively. The delegating agent overview screenshot 780 is sent to the delegating agent's device 40 once the showing assistant has been delegated the showing. Likewise, the showing assistant overview screenshot 785 can be sent to the agent device 40 associated with the showing assistant after the delegation of the showing is confirmed. Similar to other screenshots described herein, the delegating agent overview screenshot 780 and the showing assistant overview screenshot 785 can include a picture of the property to be shown, information regarding the property to be shown, etc. Each screenshot 780 and 785 can include a message section that states that the delegated showing is confirmed. The delegating agent overview screenshot 780 and the showing assistant overview screenshot 785 can include a client section 790 where information about the potential buyer can be located, such as name and potentially a photo. The client section 790 can include links that navigate to the client's email, the client's phone or to directly message the client. The delegating agent overview screenshot 780 can have a showing assistant section 800 where information about the agent who agreed to be the showing assistant can be displayed. Conversely, the showing assistant overview screenshot 785 can include a delegating agent section 805 where information about the agent who delegated the showing using the PSMS 10 can be located. The showing assistant overview screenshot 785 can also include a policy block 810 where information regarding the responsibilities of the showing assistant can be provided.

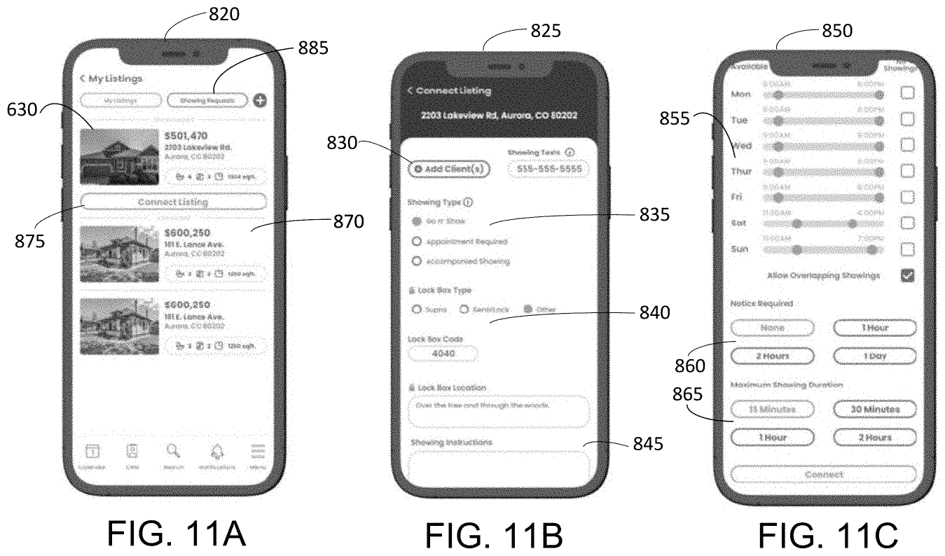

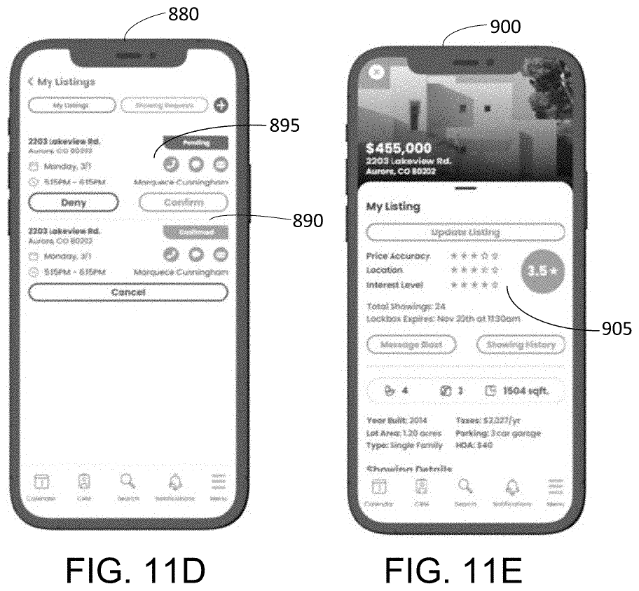

FIGS. 11A-11G depicts screenshots from an agent device 40. More specifically, these figures depict exemplary screenshots from a listing agent's device 40 when they use the PSMS 10 to manage their listings. FIG. 10A provides a listing screenshot 820 that can show a property picture 630 for every active listing for the listing agent and include other information for each listing. For each listing, the listing agent can select a listing and be sent to a first listing information screenshot 825 shown in FIG. 11B. The first listing screenshot 825 depicts a screen where the listing agent can enter information into the PSMS 10 about the listed property. The first listing information screenshot 825 has a client portion 830 where the listing agent can enter information about the client, such as the client's name. The client information can also be selected from information already stored on the PSMS 10. The first listing information screenshot 825 can also include a showing type section 835 where the agent can provide the type of showing the listing has. For example, the listing can be categorized as a courtesy listing where the listing agent would just require a courtesy notice that a showing is going to occur for the listed property or it could be listed as a listing where no notice is required to be sent to the listing agent when the property is shown. The showing type section 835 can also provide information about whether the showing requires accompaniment by the listing agent or the seller. The first listing information screenshot 725 in FIG. 11B can also include a lockbox code section 840 where the listing agent can enter the type of lockbox used at the property and, in some situations, provide the code to the lockbox used on the property. This would be a situation where the listing agent has their own lockbox and not a smart lockbox associated with the PSMS 10 described herein. The first listing information screenshot 825 can also include an information section 845 where any information about the property can be provided by the listing agent, such as any specific instructions about showing a particular property. Once all information desired to be input at the screen shown in the first listing information screenshot 725, the listing agent may go to another screen to enter additional information about the listing.

FIG. 11C shows a showing time screenshot 850 where the listing agent can enter in information relative to when a specific property can be shown. The showing time screenshot 850 can include a date and time section 855 where the listing agent enters the times and days the listed property can be shown. The showing time screenshot 850 can also include a notice section 860 where the agent can enter or select the type of notice the listing agent, and potentially the seller, requires from an agent for the particular property. For example, the listing agent may require no notice for the property to be shown. A no notice situation might occur if the property was not being occupied. The listing agent, via the notice section 860, can set a desired length of time prior to the showing that the listing agent must be notified of the showing. The showing time screenshot 850 can also include a duration section 865 where the listing agent can provide a maximum showing duration if this is desirable for a particular listing. Once information has been entered into the PSMS 10 via the screen displayed by the showing time screenshot 850 on the agent device 40, the listing agent can go back to the screen shown in FIG. 11A, which provides listings by a listing agent that has signed up or is registered with the PSMS 10 and added their listed properties to the PSMS 10. A connected listing section 870 shown on the listing screenshot 820 includes all the agent's registered listings depicted by property pictures 630. The listing screenshot 820 can also show the listings that have not been connected via the PSMS 10 and provides a connect button 875 that permits the listing agent to deal with the listing as desired.

FIG. 11D shows a showing schedule screenshot 880 that loads on the agent device 40 when a showing button 885 is activated by the listing agent. The showing schedule screenshot 880 provides a list of confirmed showing tabs 890 and shows an option popup 895 where the agent can deny or confirm a showing at a given time of the listing agent's listed property. The confirmed showing tabs 890 can show details related to the confirmed or attempted showing. In another embodiment, the showing schedule screenshot 870 can include information regarding denied showing requests. FIG. 11E is a feedback screenshot 900 that has information about the property and a feedback section 905 where ratings can be given regarding various aspects of the property that was shown. The number of showings that particular property can be provided as well.

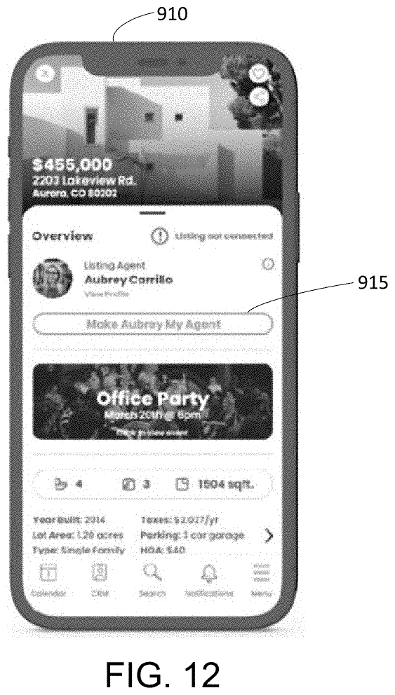

In certain situations, a prospective buyer is not connected to an agent and accesses the PSMS 10 via the consumer device 30 and views a particular listing. In this scenario, the prospective buyer is not given a choice to try and schedule a showing for this property because the listing agent has required that any potential buyer of the property associated with the listing has to be represented by the listing agent for that property. In these situations, the prospective buyer sees a listing lead screenshot 910, shown in FIG. 12, on their consumer device 30. The listing lead screenshot 910 has an agent button 915 that the prospective buyer can activate to make the listing agent their agent, thus making a showing of the property to the prospective buyer possible.

Agents and prospective buyers that are linked on the PSMS 10, either at registration, a lead generation operation or a delegation operation, can communicate through the PSMS 10 via the communicator interface 200 of the showing control system 20. It is also contemplated that the professional service providers, via the professional devices, could use the PSMS 10 to work with agents, prospective buyers and sellers, and other professional services providers with respect to various stages of the home selling process.

From the above description, it is clear that the present invention is well-adapted to carry out the objectives and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

1. A property showing management system for managing showings of a listed property, the property showing management system comprising:
a consumer device associated with a prospective buyer who requests a showing of a listed property at a specific date and time;
an agent device associated with a real estate agent who can conduct showings of listed properties; and
a showing control system for performing the operations of the property showing management system, the showing control system receives a showing request from the prospective buyer via the consumer device, determines that the prospective buyer is linked to a specific agent but the specific agent cannot conduct the showing at the desired time and date of the prospective buyer and conducts a delegation operation to determine a delegated agent to conduct the showing of the listed property to the prospective buyer at the desired date and time, the showing control system generates a unique session ID for the showing and transmits, over the computer network, the unique session ID to the agent device and to a smart lockbox attached to the listed property, the smart lockbox is configured to grant access to an internally stored key to facilitate access to the listed property by the agent responsive to verification, by a security circuit of the smart lockbox, of the unique session ID from the agent device, wherein the showing control system generates and transmits, to the smart lockbox, a different unique session ID for each showing of the listed property.

2. (canceled)

3. The system of claim 1 wherein the showing control system uses an availability and permissions process to determine the approval of showings on a particular property.

4. The system of claim 3 wherein the delegation operation includes the showing control system receiving information from a delegating agent scheduled to do a showing that the delegating agent cannot conduct the showing and notification of an incentive offered by the delegating agent for a delegated agent to receive to conduct the showing for the delegating agent, the showing control system sending notification to agents regarding details of the showing and the incentive offered by the delegating agent to conduct the showing and receiving notification from the delegated agent accepting the incentive and agreeing to conduct the showing of the listed property to the prospective buyer.

5. The system of claim 4 wherein the incentive offered by the delegating agent is a certain amount of money and a portion of the certain amount of money is retained by the property showing management system.

6. (canceled)

7. (canceled)

8. The system of claim 1 wherein an owner of a listed property or a listing agent can approve or deny a requested showing by the prospective buyer or an agent associated with the prospective buyer.

9. The system of claim 1 wherein the showing control system determines whether a consumer who accesses the property showing management system has an agent and initiates a client connection process if the consumer does not have an agent.

10. A method of managing showings of listed properties via a property showing management system, the method comprising:
receiving a showing request of a listed property from a prospective buyer for a specific date and time, the showing request received by a showing control system of the property showing management system, the showing control system performs the operations of the property showing management system, the property showing management system further comprising:
a consumer device associated with the prospective buyer who made the showing request of the listed property at the specific date and time; and
an agent device associated with a real estate agent who can conduct showings of listed properties;
determining whether the prospective buyer is linked to a specific agent;
determining the specific agent linked to the prospective buyer cannot conduct the showing at the specific date and time requested by the prospective buyer;
conducting a delegation operation to determine a delegated agent who can conduct the showing at the specific date and time requested by the prospective buyer;
notifying the delegated agent of the showing date and time;
generating a unique session ID, via the showing control system, for the showing and transmits, over a computer network, the unique session ID to the agent device and to a smart lockbox attached to the listed property, the smart lockbox is configured to grant access to an internally stored key to facilitate access to the listed property by the agent responsive to verification, by a security circuit of the smart lockbox, of the unique session ID from the agent device, wherein the showing control system generates and transmits, to the smart lockbox, a different unique session ID for each showing of the listed property.

11. (canceled)

12. The method of claim 10 wherein the showing control system uses an availability and permissions process to determine the approval of showings on a particular property.

13. The method of claim 10 further comprising sending an invitation to an agent to use a property showing management system to manage property listings of the agent, receiving registration information from the agent and linking the agent to property listings and prospective buyers associated with the agent.

14. The method of claim 10 wherein an owner of a listed property or a listing agent can approve or deny a requested showing by the prospective buyer or an agent associated with the prospective buyer.

15. The method of claim 10 wherein the showing control system determines whether a consumer who accesses the property showing management system has an agent and initiates a client connection process if the consumer does not have an agent.

16. The method of claim 10 further comprising receiving information from a delegating agent scheduled to do a showing that the delegating agent cannot conduct the showing, providing notification of an incentive offered by the delegating agent for a delegated agent to receive to conduct the showing for the delegating agent, sending notification to agents regarding details of the showing and the incentive offered by the delegating agent to conduct the showing and receiving notification from the delegated agent accepting the incentive and agreeing to conduct the showing of the listed property to the prospective buyer.

17. The method of claim 16 wherein the incentive offered by the delegating agent is a certain amount of money and a portion of the certain amount of money is retained by the property showing management system.

18. (canceled)

19. (canceled)
